(19) United States
(12) Patent Application Publication
(10) Pub. No.: US 2005/0259958 A1
(43) Pub. Date: Nov. 24, 2005

(54) Automatic indexing of digital video recordings

(76) Inventor: Ivan Johansson, Motala (SE)

Correspondence Address: HARRINGTON & SMITH, LLP, 4 RESEARCH DRIVE, SHELTON, CT, 06484-6212, US

(21) Appl. No.: 10/480,944

(22) PCT Filed: Jun. 22, 2001
(86) PCT No.: PCT/EP01/07646

§ 371 Date: Jun. 1, 2004

(51) Int. Cl. H04N 5/783

(52) U.S. Cl. 386/69; 386/125

(57) ABSTRACT

A digital television system includes service provider equipment for transmitting a digital television broadcast, a set-top box for receiving and recording and decoding the digital television broadcast and displaying the decoded broadcast and/or recording on an analog or digital television. A processor arranged in the set-top box or the user equipment includes an agent or computer program for extracting information transmitted with the digital television broadcast, selecting filtering alternatives based on the information and for providing to the recording indexes associated with the recording position of events filtered out using the selected filtering alternatives.

The present invention relates to the field of digital video recording and playback systems, and particularly to a method and apparatus for automatically indexing program content during recording of a digital video signal, especially recording of a digital video signal to video recording media such as magnetic discs or writeable optical discs or static memory circuits.

Many countries, including the United States, are in the process of switching television broadcasting systems from analog broadcasting system to Digital Television (DTV) broadcasting systems in which television programs are broadcast using digital signals. Where DTV broadcasting has already been implemented (e.g., Europe and selected U.S. locations), set-top boxes enable analog televisions to receive and decode digital television (DTV) broadcasts. The set-top boxes include one or more microprocessors for running the operating system required for translating the digital signal to an analog signal and for providing ancillary functions for the convenience of the user. The provider or transmitter of the DTV broadcast may also transmit further information with the DTV broadcast which includes details for automatic configuration of the set-top box for receiving the program. In addition to the details for automatic configuration, the information may also include information about the broadcast itself for the user's benefit. The information may be defined by a standard such as the Service Information (SI) defined in European Telecommunication Standard 300 468, “Digital Video Broadcasting; Specification for Service Information (SI) in DVB Systems”. Alternatively, the information may be transmitted using techniques developed by the Advanced TV Enhancement Forum (ATVEF).

It is commonplace to record a commercially broadcast television program on a video tape recorder (VTR, also referred to as a video cassette recorder or VCR) for viewing at a later time. There are VCRs on the market that lets the user manually insert indexes for interesting portions during such recordings. When later viewing the recorded program these indexes assists the viewer in locating the interesting portions through letting the VCR search for a specific index or alternatively scan through the indexes.

One prior art approach to semi-automatic indexing has been to have a multimedia search and indexing system automatically selects scenes or events of interest from any media, i.e., video, film, sound for replay, in whole or in part, in other contexts. The entire audio track of a recorded event in video, film, sound, etc., is analyzed to determine audio levels within a set of frequency ranges of interest. Audio clip levels within the selected frequency ranges are chosen as audio cues representative of events of interest in the track. The selection criteria are applied to the audio track of the recorded event. An Edit Decision List (EDL) is generated from the analysis of the audio track. The list is representative of scenes or sounds of interest as clips for reuse. The clips are reviewed and accepted or rejected for reuse. Once selected, the clips are edited using industry standard audio and video editing techniques. A system of this type is disclosed in EP0969399, to IBM.

An object of the present invention is to provide a method and apparatus for controlling the operation of a digital video recording and playback device so as to automatically insert indexes representative of potentially interesting passages, scenes or events during recording of a digital television signal.

The object according to the present invention is met by a processor which uses information transmitted with a digital television (DTV) broadcast, e.g. DVB-SI Content Descriptors according to Digital Video Broadcasting (DVB); Specification for Service Information (SI) in DVB systems, EN 300 468 V1.3.1 (1998-02), European Telecommunications Standards Institute. The standardized Content Descriptors identifying the genre of the current event are used for selecting appropriate filtering alternatives for determining how to provide automatic indexing of interesting passages or scenes of the event being recorded, e.g. sports (general), (or even sub groups for specific sports such as football/soccer, motor sport or tennis/squash), where the filtering alternative could be set to trigger on increased audio noise level, such as applause, the roar of the crowd, blowing of a whistle etc, scoreboards visible in the image or superimposed thereon. For another category, e.g. movie/drama (general), sub group detective/thriller the filtering alternative could be preset for darkened pictures, suggestive music, sudden noises on quiet background etc. In a similar manner appropriate filtering alternatives can be customized for other event types identified by other content descriptors.

A digital television system comprises service provider equipment including a transmitter for transmitting the DTV broadcast, a set-top box arranged for receiving and decoding a digital video broadcast transmitted by the service provider equipment, a display device such as a television or a monitor, and a user input device. The function of the set-top box may alternatively be incorporated into the display device. According to the present invention, the system further includes a processor in either the set top box or the DTV service provider equipment, the processor being sensitive to information transmitted with a digital television (DTV) broadcast, e.g. DVB-SI Content Descriptors. The processor further comprises an agent or computer program for adapting the filtering to settings/profiles corresponding to topics related to the DTV broadcast currently being viewed/recorded. The agent determines the appropriate filtering settings from descriptor fields of information transmitted with the DTV broadcast. The descriptor fields may include a description of the subject matter of the broadcast, the title of the broadcast, or a list of keywords specifically included in the information to be used by the agent to conduct the filtering setting operation. Furthermore, the format of the information may be defined by a standard such as Service Information (SI) defined in European Telecommunication Standard 300 468, “Digital Video Broadcasting; Specification for Service Information (SI) in DVB Systems”. Furthermore, the information may be transmitted using techniques developed by the Advanced TV Enhancement Forum (ATVEF) which may be viewed at the date of the application at www.atvef.com.

In a further embodiment, the processor with the agent or computer program may be arranged in a computer arranged between the set-top box and the television.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

In the drawings, wherein like reference characters denote similar elements throughout the several views:

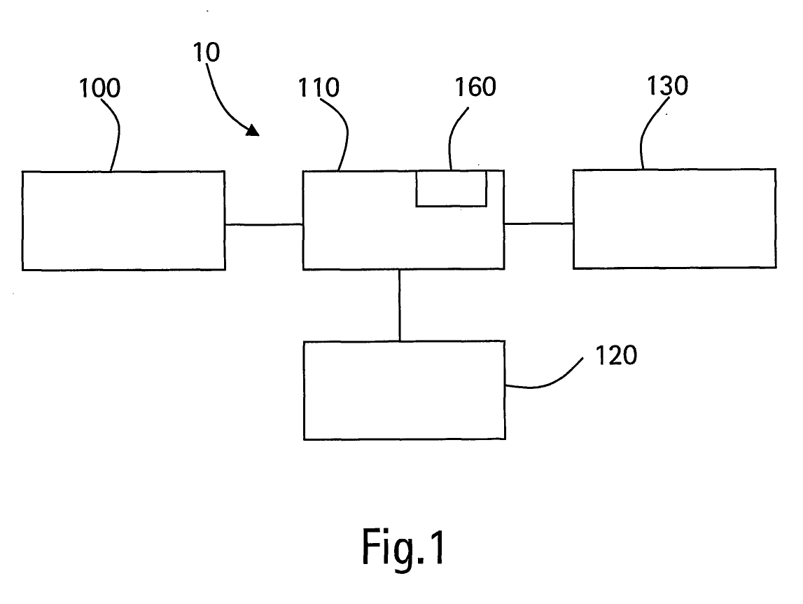

FIG. 1 discloses a digital television system according to a first embodiment of the present invention;

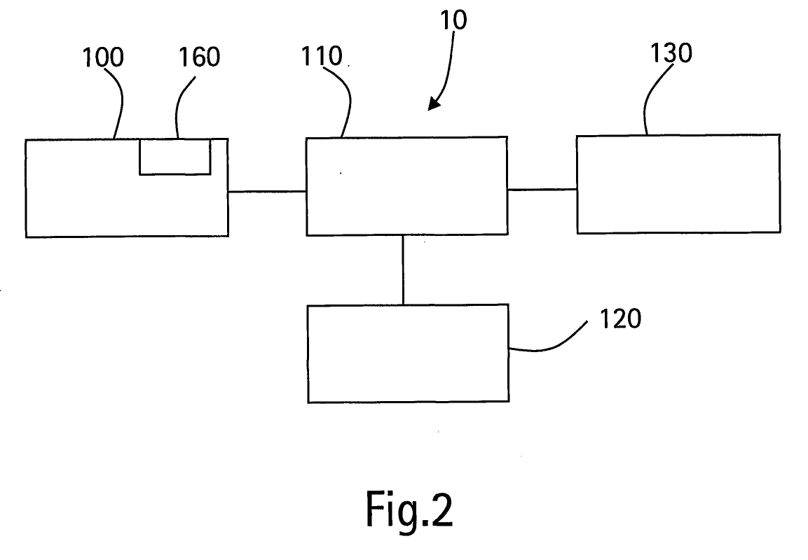

FIG. 2 discloses a digital television system according to a second embodiment of the present invention; and

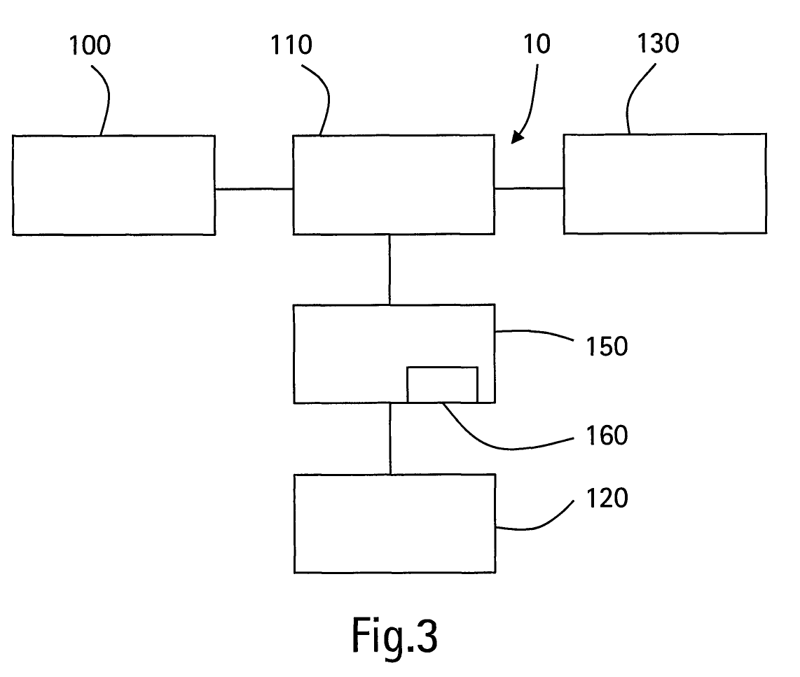

FIG. 3 discloses a digital television system according to a third embodiment of the present invention.

FIG. 1 shows a digital television system 10 according to an embodiment of the present invention comprising a set-top box (STB) 110 including a processor 160 for receiving and decoding a digital television (DTV) broadcast transmitted by provider equipment 100 and a display 120 connected to the STB 110. The connection between the provider equipment 100 and the STB may comprise any wired or wireless connection including, for example, an antenna connection for a terrestrial broadcast signal, a cable connection, or a satellite connection, e.g. wherein a parabolic satellite dish is and an associated low noise block converter (LNB) is used for receiving a satellite transmission. In this embodiment, the display 120 comprises a television. The display 120 receives the decoded DTV broadcast from the STB 110 and displays it. A user input 130 is connected to the STB 110 for channel selection and for setting up the STB 110 to the user's preferred settings. The connection between the STB 110 and the user input 130 may comprise a wired connection or a wireless connection, e.g. such as an infrared connection normally provided by a television remote control (RC). The provider equipment 100 also transmits information along with the DTV broadcast which includes DTV broadcast data used by the STB 110 for automatic configuration of the STB 110 for receiving the DTV broadcast information. The information further includes descriptor fields including descriptions, text messages, or other data intended to provide information to the user about the broadcast. The descriptor fields are not intended to control operation of the STB 110. The descriptor fields may include the title of the broadcast, the subject of the broadcast, keywords related to the subject matter of the broadcast. The information transmitted with the DTV broadcast may be defined by a standard such as the Service Information (SI) defined in European Telecommunication Standard 300 468, “Digital Video Broadcasting; Specification for Service Information (SI) in DVB Systems”. Furthermore, the information may be transmitted using techniques developed by the Advanced TV Enhancement Forum (ATVEF) which may be viewed at the date of the application at www.atvef.com.

According to the present invention, the processor 160 of the STB 110 uses information transmitted with a digital television (DTV) broadcast, e.g. DVB-SI Content Descriptors according to Digital Video Broadcasting (DVB); Specification for Service Information (SI) in DVB systems, EN 300 468 V1.3.1 (1998-02), European Telecommunications Standards Institute. The standardized Content Descriptors identifying the genre of the current event is used for selecting appropriate filtering alternative settings for determining how to identify potentially interesting passages or scenes in the event and provide automatic indexing of such interesting passages or scenes of the event being recorded, e.g. sports (general), (or even sub groups for specific sports such as football/soccer, motor sport or tennis/squash), where the filtering alternative could be set to trigger on increased audio noise level, such as applause, the roar of the crowd, blowing of a whistle etc, scoreboards visible in the image or superimposed thereon. For another category, e.g. movie/drama (general), sub group detective/thriller the filtering alternative could be preset for darkened pictures, suggestive music, sudden noises on quiet background etc. The processor 160 comprises an agent or computer program for adapting the filters of a particular filtering alternative to settings/profiles corresponding to topics related to the DTV broadcast currently being viewed/recorded. The agent or computer program determines the appropriate filter settings from the descriptor fields of information transmitted with the DTV broadcast. The agent or computer program is set to extract information transmitted with the digital television broadcast being recorded, the information including descriptor fields including terms related to the digital television broadcast and selecting filtering alternatives based on the terms in the descriptor fields of the information. Thereafter the agent or computer program filters out events corresponding to the selected filtering alternatives and provides to the recording of the digital television broadcast indexes associated with the recording position of events filtered out using the selected filtering alternatives. The filters can be set to operate both on the audio and the video information for the determination of interesting passages or scenes in the event being recorded, e.g. audio filtering can be set to trigger on pre-defined frequencies, sudden occurrences of sharp sounds etc, while the video content can be screened for e.g. scoreboard like parts or sudden occurrences of bright flashes etc, such as would be present e.g. if an explosion is shown in an action category event. Results of the audio and video filtering can also be combined to determine an interesting passage, e.g. the combination of a sharp sudden sound with the flash of an explosion. The agent or program can be set to immediately start the filtering and indexing when recording of a broadcast is initiated, alternatively the processor 160 may wait for a time period (i.e., until a scheduled recording time) if selection of a broadcast to be recorded at a later time is made. From the user's perspective, video programs are recorded as on any standard VCR. However, the device is transparently performing the filtering and indexing functions while recording is in progress. The filtering and indexing phase is normally terminated whenever the STB stops recording (whether by manual action, lack of recording space, timer or other function). Recording in the STB can be made to any recording medium, such as a magnetic disc, a writeable optical disc or to a static memory circuit. Furthermore, the processor may alternatively wait for a “index” command from the user input 130 before starting the automatic filtering and indexing instead of automatically performing an automatic filtering/indexing session upon initiation of the recording session. The user or the manufacturer of the processor 160 may select which of these options is the default option.

When a user is recording a broadcast, the topic/genre of the broadcast or topics related thereto is read from the descriptor fields of information transmitted with the DTV broadcast and used to determine the appropriate filter settings. The descriptor fields may include a description of the subject matter of the broadcast, the title of the broadcast, or a list of keywords specifically included in the information to be used by the agent or computer program to conduct the filter setting operation. The list of alternative filter settings to be used by the processor 160 during recording may be displayed to the user on the display 120 during viewing of the broadcast upon request via the user input 130. Alternatively, the list of alternative filter settings may be stored in a memory device in the STB 110. For example, if a user is watching a football game, the filter may be set to trigger on increased audio noise level, such as applause, the roar of the crowd, blowing of a whistle etc, scoreboards visible in the image or superimposed thereon. As the user is recording the game, the agent or computer program of the processor 160 uses the descriptor fields in the information transmitted with the DTV broadcast to select an appropriate filtering alternative in order to filter out and provide indexes corresponding to the recording position of the potentially interesting occurrences of such information in the game corresponding to the predetermined filtering alternative, and provides a number of indexes for the users benefit when later reviewing the recording. The user may display the list of filtering alternatives on the display 120 by inputting a request via the user input 130. When the list is displayed, the user may select any one of the filtering alternatives on the list to obtain further information about the used filtering criteria and/or edit the filtering criteria in accordance with personal preferences.

As evidenced by the above example, the content of the descriptor fields in the information transmitted with the DTV broadcast determines which filtering alternatives are used. The descriptor fields may include keywords which are specifically included in the descriptor fields by the provider to be used for the purpose of selecting an appropriate filtering alternative. The information transmitted by the provider with the DTV broadcast must have a defined structure so that the processor 160 can retrieve the descriptor fields for use in selecting the filtering alternative. Of course, the provider may also include a list of filtering alternatives in the information transmitted with the DTV broadcast.

After the filtering and indexing has been performed and the recording is completed, the user may request a preview scan of the indexed parts of the recording via the user equipment 130. Once the user requests the preview scan, the STB 110 may display the indexed events from the broadcast on the display 120 for a predetermined preview time period, e.g. 10 seconds. Alternatively, playback may be initiated from the position corresponding to the first index of the recording and continue until the viewer request a jump to the next index position via the user equipment 130. Furthermore, the STB 110 may be arranged for displaying a list of indexes in the recording currently being viewed on the display 120 and providing for jumping between any index displayed in the list in response to commands from the user input 130.

Instead of being arranged in the STB 110, a processor 160 comprising the agent or computer program for filtering and indexing programs provided in a network may alternatively be arranged at the provider equipment 100, as shown in FIG. 2. This embodiment may be used if the STB 110 is provided with the ability of filtering out such indexes from the broadcast stream and inserting them into the recording during reception of a DTV broadcast.

In yet a further embodiment shown in FIG. 3, a computer 150 having a central processing unit (CPU) is connected between the STB 110 and the display 120. In this embodiment, the display 120 may comprise a monitor. The computer 150 may be arranged as a digital video recorder, e.g. using its magnetic hard disk drive or a built in writeable optical disc storage unit or even a static memory circuit thereof. In this embodiment, the user input 130 is connected to the computer 150 and may comprise a conventional computer input such as a keyboard or a mouse. Alternatively, the user input 130 may comprise a control device specifically designed for controlling the functions of an STB 110, such as a remote control unit (RC) using infrared communication. The connections between the STB 110, the computer 150, and the display 120 may be wired or wireless. The computer 150 comprises, among other things, a means for performing the functions of the processor 160 according to the present invention for using information transmitted with a digital television (DTV) broadcast, e.g. DVB-SI Content Descriptors, for identifying the genre of the current event and using this information for selecting appropriate filtering alternatives, related to the topic of the current broadcast being viewed, for determining how to provide automatic indexing of interesting passages or scenes of the event being recorded. The processor 160 may comprise an integral part of the central processing unit of the computer 150 or it may be an additional processor dedicated to the DTV system 10.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A system for indexing events within a recording of a digital television broadcast, comprising a processor operatively arranged for receiving information transmitted with the digital television broadcast being recorded, the information comprising descriptor fields containing terms related to the broadcast, wherein said processor is further operatively arranged for selecting filtering alternatives based on the information and for providing to the recording indexes associated with the recording position of events filtered out using the selected filtering alternatives.

2. The system of claim 1, wherein the information transmitted with the digital television broadcast comprises service information.

3. The system of claim 1, wherein the information transmitted with the digital television broadcast comprises information transmitted in Advanced TV Enhancement Forum techniques.

4. The system of claim 1, wherein said processor is operatively arranged for determining the appropriate filter settings from information contained in descriptor fields of information transmitted with the DTV broadcast as Service Information (SI) defined in European Telecommunication Standard 300 468, “Digital Video Broadcasting; Specification for Service Information (SI) in DVB Systems”.

5. The system of claim 4, wherein the terms in the descriptor field of the information transmitted with digital television broadcast comprise at least one of a title of the broadcast, a subject of the broadcast, and keywords related to the broadcast.

6. The system of claim 1, wherein said processor is operatively arranged for selecting filter settings based on the information associated with an event selected for later recording upon time delayed automatic initiation of the recording.

7. The system of claim 1, wherein said processor is arranged in a set-top box of a digital television system.

8. The system of claim 1, wherein said processor is arranged in service provider equipment of a digital television system.

9. The system of claim 1, further comprising a computer connected between a set-top box and a display of the digital television system, wherein said processor is arranged in said computer.

10. The system of claim 1, further comprising means for displaying a list of filtering alternatives to the user, whereby the user may select any one of the filtering alternatives on the list to obtain the further information about the used filtering criteria and/or edit the filtering alternative in accordance with personal preferences.

11. A process for indexing events within a recording of a digital television broadcast, comprising the steps of:
receiving information transmitted with the digital television broadcast, the information including descriptor fields including terms related to the digital television broadcast;
selecting filtering alternatives based on the terms in the descriptor fields of the information; and
providing to the recording indexes associated with the recording position of events filtered out using the selected filtering alternatives.

12. The process of claim 11, wherein said step of receiving comprises receiving service information transmitted with the digital television broadcast.

13. The process of claim 11, wherein said step of receiving comprises receiving information transmitted with the digital television broadcast in Advanced TV Enhancement Forum techniques.

14. The process of claim 11, wherein said step of selecting comprises selecting filtering alternatives using a manual input device.

15. The process of claim 14, wherein the information transmitted with digital television broadcast comprises at least one of a title of the broadcast and a subject of the broadcast.

16. The process of claim 11, wherein said step of selecting comprises selecting filtering alternatives based on the information associated with a event selected for later recording upon time delayed automatic initiation of the recording.

17. The process of claim 11, further comprising the step of inputting the terms into the descriptor fields by a provider of the digital television broadcast before said step of receiving.

18. The system of claim 11, further comprising the step of displaying the list of filtering alternatives in response to a user input.

19. A digital television system, comprising:
a service provider equipment for transmitting digital television broadcasts;
a set-top box for receiving and recording and decoding the digital television broadcasts;
a display for displaying the decoded digital television broadcasts and recordings;
a user input for selecting a channel of the digital television broadcasts to be displayed and/or recorded; and
a processor operatively arranged for receiving information transmitted with the digital television broadcast, the information including descriptor fields containing terms related to the broadcast, wherein said processor is further operatively arranged for selecting filtering alternatives based on the information and for providing to the recording indexes associated with the recording position of events filtered out using the selected filtering alternatives.

20. The system of claim 19, wherein said processor is arranged in said set-top box.

21. The system of claim 19, wherein said processor is arranged in said service provider equipment.

22. The system of claim 19, further comprising a computer arranged between said set-top box and said display, wherein said processor is arranged in said computer.

23. The system of claim 19, further comprising means for displaying the list of filtering alternatives on said display in response to said user input.

24. A computer program product directly loadable into the internal memory of a digital computer comprising software code portions for performing the following steps when said product is run on a computer:
extracting information transmitted with a digital television broadcast, the information including descriptor fields including terms related to the digital television broadcast;
selecting filtering alternatives based on the terms in the descriptor fields of the information; and
filtering out events corresponding to the selected filtering alternatives; and
providing to a recording of the digital television broadcast indexes associated with the recording position of events filtered out using the selected filtering alternatives.

25. A computer program product stored on a computer readable storage medium, comprising computer readable program code means for causing a computer to perform the following steps:
extracting information transmitted with a digital television broadcast, the information including descriptor fields including terms related to the digital television broadcast;
selecting filtering alternatives based on the terms in the descriptor fields of the information; and
filtering out events corresponding to the selected filtering alternatives; and
providing to a recording of the digital television broadcast indexes associated with the recording position of events filtered out using the selected filtering alternatives.
